(19) United States
(12) Patent Application Publication
(10) Pub. No.: US 2004/0182204 A1
(43) Pub. Date: Sep. 23, 2004

(54) Pair of tongs for opening and/or closing of tins for paints, chemicals and the like

(76) Inventors: Bengt Bjorklund, Haninge (SE); Ove Saberg, Hasselby (SE); Halvard Astrom, Tyreso (SE)

Correspondence Address: OSTROLENK FABER GERB & SOFFEN, 1180 AVENUE OF THE AMERICAS, NEW YORK, NY, 100368403

(21) Appl. No.: 10/712,959

(22) Filed: Nov. 13, 2003

(30) Foreign Application Priority Data
Mar. 21, 2003 (SE) SE 0300840-6

(51) Int. Cl. B67B 7/16

(52) U.S. Cl. 81/3.55

(57) ABSTRACT

The present invention relates to a pair of tongs for opening and/or closing of tins for e.g. paintings, chemicals and the like and comprising two legs (4,5), which are pivoted around an axis (6) and said legs (4,5) are provided with gripping and nipping means (7) in its front portion. The one or upper leg (4) in its free end (10) is provided with a protrudable tongue formation (8), which in its active position is displaceable inwards under the folded edge (9), which extends around a lid (3) for closing of a tin (2), at the same time as at least one supporting formation (12) in the other or lower legs' (5) free end (11) extends upwards and is passing the tongue formation (8) and inwards over an outer, upper free edge (13) of a tin (2) in order to support against said edge, so that during a pressing together of the legs (4,5) said tongue formation (8) is lifting upwards or separates the lid from the tin (2) during a simultaneous pressing of the supporting formation (12) against the upper edge (13) of the tin (2).

The present invention refers to a pair of tongs for opening and/or closing of tins for e.g. paints, chemicals and the like and comprising two legs, which are pivoted around an axis and said legs have in the free or front end gripping and nipping means.

When tins, now existing on the market, shall be opened some type of chisel is usually utilized, which is inserted between the groove of the lid and the periphery of the tin in order to open or take away the lid. In many cases this operation has been very difficult and especially now in the latest time when said groove between the lid and the periphery of the tin opening is very small. Owing to environment— and transporting requirements lids and pins have lately been formed in such a way that the lid is fastened harder than before in prevailing of leakage for example if a tin is dropped or a pallet of pins is tilted. When bending against the upper edge of the tin in order to try to release the lid from the tin the edge will be deformed with the result that the tins is difficult to re-close with a belonging lid, so that said lid can keep tighten against the remaining paints and the like in the tin. An alternative for the screw chisel or a similar means is to use flat pairs of tongs or common cutting off tongs for these purposes but also in these cases the edge portions of the lid and the tin can easily be deformed, so that it will be difficult to achieve a tightened package when closing the tin. On the market there are also a new type of opening device, which in one end is specially formed for opening of beer bottles, Coca-Cola bottles and the like, and the other end of which is formed such as a flat, screw chisel formed portion, which is intended for opening of paint tins but also when using this tool a large effort is required and special steps of carefulness must be used during the opening, so that the edge portions of the tin and lid shall not be deformed.

The object of the present invention is to provide a new type of a pair of tongs, which is intended especially for opening of this mentioned new type of paint tins and which by using a simple operations both can loosen the lid from the tin and also close the same. The characterizing features of the invention are set forth in the following claims.

Thanks to the invention a new type of pair of tongs has been provided, which is intended especially for opening tins of the type mentioned above and which in an excellent way fulfils its purpose at the same time as it is also relatively simple and cheap to manufacture. The pair of tongs according to the present invention is in its tongue or gripping portion provided with a displaceable tongue, which extends along the upper leg and in this way by a simple operation can be displaced in under the folded edge of the lid. Hereafter the legs are pressed together, so that the lid is urged to separate from the tin. During this moment of operation the front portion of the lower legs is formed like a jaw in providing of a support against the upper edge of the tin in connection with the pressing together of the legs and the lifting upwards movement of the lid by the tongue. During the closing of the lid the same jaw formations on the upper leg are used such as a support against the surrounding edge portion of the lid at the same time as the upper leg by aid of a hook formed portion is intended to grasp under the offset of the tin, so that during the pressing together of the legs the front gripping and nipping means of the pair of tongs are pressing the lid downwards in the opening of the tin.

The invention is described closer below by aid of a preferable embodiment example under reference to the drawings enclosed, in which

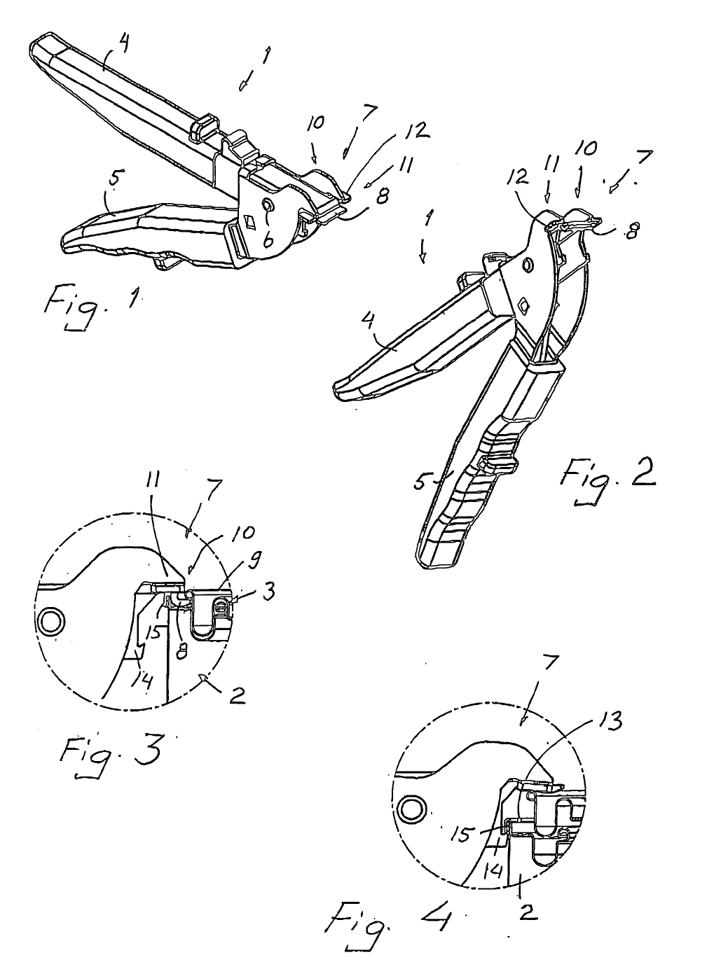

FIG. 1 shows a schematic perspective view of the appearance of a pair of tongs and when the same is in an open position,

FIG. 2 shows the same pair of tongs according to FIG. 1 in a view oblique from below,

FIG. 3 is a partial side view of the pair of tongs illustrated in FIG. 1 and 2 where it evidently can be seen how the front portion of the pair of tongs with its gripping and nipping portions work in order to open a lid, whereby the tongue of the pair of tongs in the upper leg is displaced inwards under the folded edge of the lid and which during the pressing together of the legs urges said lid to separate from the actual tin, and

FIG. 4 shows a partial view of the same type as in FIG. 3 but in which a pair of tongs is used to close a lid over a tin, whereby a hook formed portion of the front portion of the upper leg is intended to act as a support against an offset of the tin just below its upper edge, so that a support of the front portion of the lower leg is intended to co-act from above against the lid and during the pressing together of the legs in re-closing of the lid, when the front gripping and nipping means of the pair of tongs move in a direction towards each other.

As can be seen from the drawing here is illustrated a preferred embodiment example of the invention in the form of a pair of tongs 1, which is intended to open and/or close a lid 3 on a tin 2 for e.g. paints, chemicals or the like. The pair of tongs 1 comprises two legs 4 and 5, which are pivoted around an axis 6 and said legs are keeping these in a tensioned starting position apart from each other by aid of a spring means not closer illustrated in the drawings, before or after use of the front gripping and nipping means 7 of the pair of tongs. Furtheron the pair of tongs 1 can include a buttom, which is not illustrated in the drawing, which is provided to keep the same in a closed position when not used. The one or upper leg 4 of the pair of tongs 1 has a protrudable tongue formation B in the area of its free end 10, said tongue formation 8 in its active position extends in under a folded edge 9, which runs around a lid 3 for closing of a tin 2. Furtheron the pair of tongs 1 comprises at least one supporting formation 12 in its other or free end 11 of the lower leg 5, which extends in a direction upwards and past together of the tongue formation 8 and in over an outer, upper free edge 13 of the tin 2 itself. The supporting formation 12 is provided to support against said edge 13, so that during a pressing together of the legs 4 and 5, the tongue formation 8 is lifting up or separates the lid 3 from the tin 2 during a simultaneous pressing of said supporting formation 12 against the edge 13.

In the embodiment example illustrated here the other or lower leg 5 comprises two supporting formations 12, which each is situated on each side of said tongue formation 8.

The one or upper leg 4 of the pair of tongs 1 further comprises at least one hook formed portion or hook formation 14, which is located below the outwards and inwards displaceable tongue formation 8, and which hook formation 14 can be pressed against the underside of an offset 15 extending around the upper edge 13 of the tin 2 at the same time as said supporting formations 12 on the other or lower leg 5 are pressed against the lid 3 from above and against its folded edge 9 during the pressing together of the legs 4 and 5 in order to close the lid 3 on the tin 2.

By aid of the pair of tongs according to the present invention it is thus possible both to open and to close lids over tins of the type mentioned above and which now are existing on the market and which by aid of up till now existing tools have been shown to be very difficult to open.

1. A pair of tongs for opening and/or closing of tins for e.g. paints, chemicals and the like and comprising two legs (4,5), which are pivoted around an axis (6) and said legs (4,5) are provided with gripping and nipping means (7) in its front portion, characterized in that the one or upper leg (4) in its free end (10) is provided with a protrudable tongue formation (8), which in its active position is displaceable inwards under the folded edge (9), which extends around a lid (3) for closing of a tin (2), at the same time as at least one supporting formation (12) in the other or lower legs' (5) free end (11) extends upwards and is passing the tongue formation (8) and inwards over an outer, upper free edge (13) of a tin (2) in order to support against said edge, so that during a pressing together of the legs (4,5) said tongue formation (8) is lifting upwards or separates the lid from the tin (2) during a simultaneous pressing of the supporting formation (12) against the upper edge (13) of the tin (2).

2. A pair of tongs according to claim 1, characterized in that the other or lower leg (5) comprises two supporting formations (12), which each is located on each side of said tongue formation (8).

3. A pair of tongs according to claim 1, characterized in that its one or upper leg (4) comprises at least one hook formation (14), which is located below the inwards and outwards displaceable tongue formation (8), which is able to be pressed against the underside of an offset (15) extending around the upper edge (13) of the tin (2) at the same time as the supporting formation (12) of the other or lower leg (5) is able to be pressed against said lid (3) from above and in a direction against its folded edge (9) during the pressing together of the legs (4,5) in order to close the tin (2) by said lid (3)
